(19) United States
(12) Patent Application Publication
(10) Pub. No.: US 2026/0153232 A1
(43) Pub. Date: Jun. 4, 2026

(54) FIXING STRUCTURE AND LAMP

(71) Applicants: SUZHOU OPPLE LIGHTING CO., LTD., Suzhou City (CN); OPPLE LIGHTING CO., LTD., Shanghai (CN)

(72) Inventor: Quanbiao WANG, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 19/428,265

(22) Filed: Dec. 21, 2025

Related U.S. Application Data
(63) Continuation of application No. PCT/CN2024/100510, filed on Jun. 21, 2024.

(30) Foreign Application Priority Data
Jun. 29, 2023 (CN) 202321676448.6

(51) Int. Cl. F21V 27/02; F21V 23/00

(52) U.S. Cl. CPC F21V 27/02; F21V 23/002

(57) ABSTRACT

A fixing structure and a lamp are provided. The fixing structure is configured to secure a power cord and includes a cover having a wire threading hole, and a housing disposed inside the cover. A wire threading groove is formed in the housing at a position corresponding to the wire threading hole, and the wire threading hole and the wire threading groove are configured to allow a clamping part of the power cord to pass through. A fixing part is formed between the housing and the cover, and the fixing part is configured to receive a retaining part of the power cord. The retaining part is disposed on the clamping part and protrudes relative to the clamping part in a circumferential direction of the power cord. The wire threading hole and the wire threading groove are disposed on upper and lower sides of the fixing part.

### CROSS-REFERENCE TO RELATED DISCLOSURES

This disclosure is based upon and claims the priority of PCT patent disclosure No. PCT/CN2024/100510 filed on Jun. 21, 2024, which claims priority to the Chinese patent disclosure No. 202321676448.6 filed on Jun. 29, 2023, the entire contents of which are hereby incorporated by reference herein for all purposes.

### TECHNICAL FIELD

The present disclosure relates to the technical field of lighting equipment, in particular to a fixing structure and a lamp.

### BACKGROUND

In lamp design, it is sometimes necessary to use a power cord flexible cable SR (Strain Relief) to connect the lamp body and the power cord.

### SUMMARY

The present disclosure provides a fixing structure.

The present disclosure provides a fixing structure configured to secure a power cord. The fixing structure may include: a cover having with a wire threading hole; a housing disposed within the cover, where a wire threading groove is formed in the housing at a position corresponding to the wire threading hole, and the wire threading hole and the wire threading groove are configured to allow a clamping part of the power cord to pass through.

A fixing part may be formed between the housing and the cover, the fixing part is configured to receive a retaining part of the power cord, the retaining part is arranged on the clamping part and protrudes relative to the clamping part in a circumferential direction of the power cord; the wire threading hole and the wire threading groove are respectively provided on upper and lower sides of the fixing part, and an orthographic projection of the fixing part exceeds an orthographic projection range of the wire threading hole and exceeds an orthographic projection range of the wire threading groove respectively, so as to limit and retain the retaining part in the fixing part through the wire threading groove and the wire threading hole.

The present disclosure is to provide a lamp with the above fixing structure.

It is to be understood that both the foregoing general description and the following detailed description are exemplary and explanatory only and are not restrictive of the present disclosure.

### BRIEF DESCRIPTION OF DRAWINGS

FIG. 1 is a schematic structural diagram of a lamp according to an example of the present disclosure;

FIG. 2 is an exploded view of the lamp shown in FIG. 1;

FIG. 3 is a cross-sectional view of the lamp shown in FIG. 1;

FIG. 4 is an enlarged view of the circled part in FIG. 3;

FIG. 5 is a schematic structural diagram of the cover of the lamp in FIG. 1;

FIG. 6 is a schematic structural diagram of the housing of the lamp in FIG. 1;

FIG. 7 is an enlarged view of the circled part in FIG. 6; and

FIG. 8 is a schematic structural diagram of the face ring of the lamp in FIG. 2.

### DETAILED DESCRIPTION

In order to make the purpose, technical solution, and advantages of the present disclosure clearer, the present disclosure will be described in detail below with reference to the accompanying drawings and examples.

It should be noted that to avoid obscuring the present disclosure due to unnecessary details, only the structures and/or processing steps closely related to the solution of the present disclosure are shown in the accompanying drawings, and other details irrelevant to the present disclosure are omitted.

In addition, it should be noted that the terms “comprises”, “includes” or any other variant thereof are intended to cover a non-exclusive inclusion, so that a process, method, article, or device including a series of elements not only includes those elements but also includes other elements not explicitly listed, or elements inherent to such process, method, article, or device.

Description of reference numerals used in this disclosure may include:
Lamp 100;
Fixing structure 10, fixing part 101;
Cover 1, wire threading hole 11, outer base 12, outer side wall 13, first recessed region 131, second recessed region 132, heat dissipation contact region 14, first fixing hole 15, mounting clip 16;
Housing 2, wire threading groove 21, opening 211, fixing groove 22, bottom wall 221, side wall 222, protruding part 223, installation opening 23, inner side wall 24, third recessed region 25, second fixing hole 26;
Power cord 3, wire body 31, clamping part 32, first clamping part 321, second clamping part 322, retaining part 33;
Light-emitting component 4, heat conducting member 5, lens 6, reflective prism block 61, foolproof groove 62;
Face ring 7, outer edge part 71, connecting part 72, anti-detachment groove 73, foolproof protrusion 74, third fixing hole 75, fastener 8.

To ensure the reliability and safety of the power cord, a fixing method is required to clamp it inside the lamp. Currently, the commonly used method on the market is to utilize the plastic deformation of the SR plastic to force the power cord flexible cable SR into a wire clamping device. However, this method has some difficulties and limitations, such as the power cord flexible cable SR being difficult to penetrate the wire clamping device and high pulling-in difficulty, which in turn affect the fixing efficiency, reliability, and safety.

Other implementations may propose a lamp bracket and a lamp. By arranging an extension bracket protruding from the lamp bracket and an installation hole on the extension bracket, the extension bracket prevents the tail card wire from detaching from the installation hole to avoid the tail card wire being pulled off. However, the extension bracket needs to be separately protruded outward on the bracket body, resulting in a complex structure and occupying additional space, which is not conducive to the miniaturization of the entire product. Moreover, after the tail card wire is electrically connected to the light-emitting component, it needs to be bent to install the tail card wire into the extension bracket, increasing the assembly difficulty.

In view of foregoing, it is necessary to provide a fixing structure and a lamp to solve the above problems.

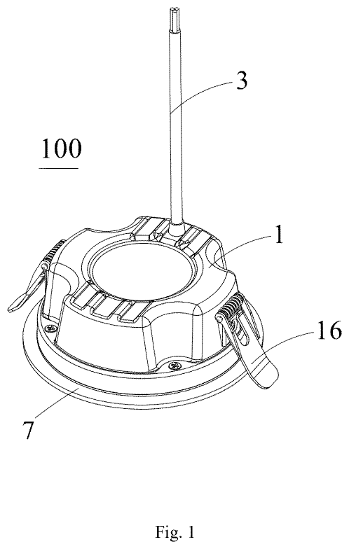

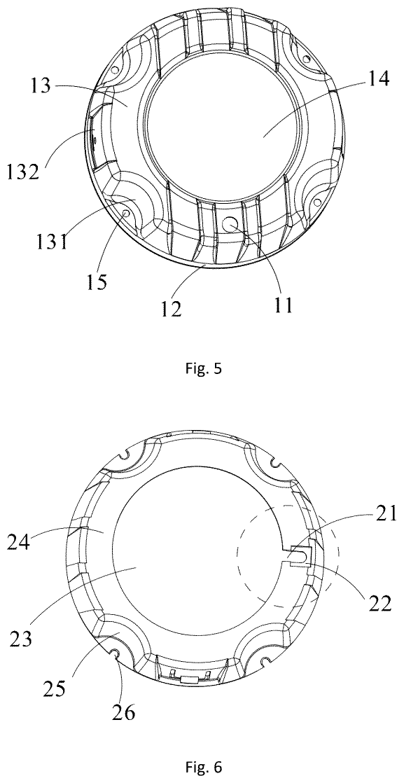

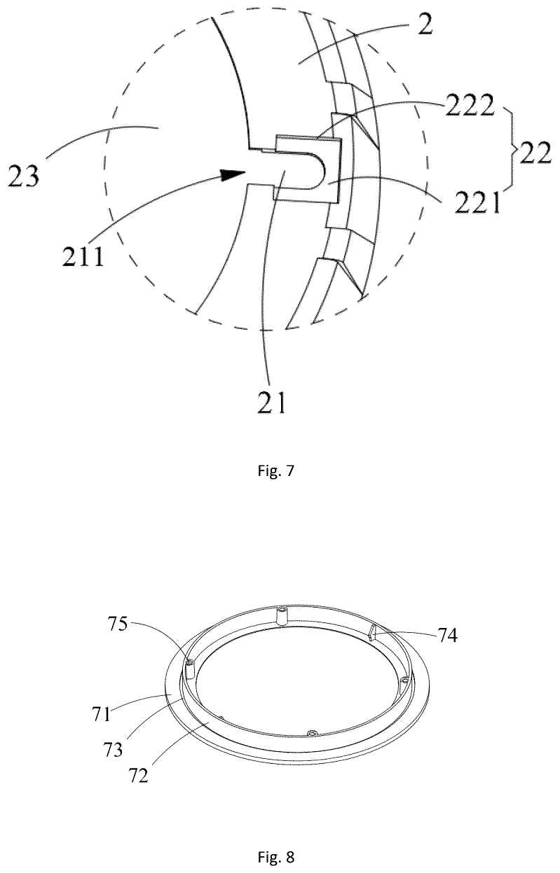

Please refer to FIGS. 1 to 8, which are schematic diagrams of a lamp 100 according to an example of the present disclosure. The lamp 100 includes a cover 1, a housing 2, a power cord 3, a light-emitting component 4, and a face ring 7. The cover 1 is sleeved on the outer side of the housing 2, and the cover 1 and the housing 2 together form a fixing structure 10 for fixing the power cord 3. The power cord 3 is fixedly connected and electrically connected with the light-emitting component 4. The light-emitting component 4 is arranged between the face ring 7 and the housing 2 and located on the side of the housing 2 away from the cover 1. When the light-emitting component 4 is fixed on the housing 2, the power cord 3 is fixed between the housing 2 and the cover 1 through the fixing structure 10. Such an arrangement is to limit and fix the power cord 3 by means of the structures of the housing 2 and the cover 1 itself, without the need to design additional wire pressing pieces, thereby reducing costs. In addition, the power cord 3 does not need to be bent during installation, threading is easy, assembly is simple and easy to operate, and it has good convenience. At the same time, the power cord 3 is firmly installed, not easy to be pulled off by external force, meets the safety regulation requirements of anti-pulling and pushing, and the lightning mark is omitted.

The power cord 3 includes a wire body 31 and a clamping part 32 arranged on the wire body 31. The diameter of the clamping part 32 is larger than that of the wire body 31, and the clamping part 32 is configured to be connected with the fixing structure 10. By arranging the clamping part 32 with a larger diameter, the firmness of the connection and fixation of the power cord 3 is improved, and the wire body 31 of the power cord 3 is prevented from breaking.

Further, the power cord 3 further includes a retaining part 33. The retaining part 33 is arranged on the clamping part 32 and protrudes relative to the clamping part 32 in the circumferential direction of the power cord 3. That is to say, the retaining part 33 is arranged on the clamping part 32, and the volume of the retaining part 33 is larger than that of the clamping part 32. Such an arrangement is to facilitate the clamping part 32 to pass through the fixing structure 10 of the lamp 100, while the retaining part 33 is limited and fixed.

Further, the clamping part 32 includes a first clamping part 321 arranged above the retaining part 33 and a second clamping part 322 arranged below the retaining part 33. The first clamping part 321 is used to pass through the wire threading hole 11 on the cover 1, and the second clamping part 322 is used to pass through the wire threading groove 21 on the housing 2. For example, the shape of the first clamping part 321 is different from that of the second clamping part 322 to distinguish the installation direction of the power cord 3.

The diameter of the end of the first clamping part 321 proximal to the retaining part 33 is larger than that of the end distal to the retaining part 33. Such an arrangement makes the first clamping part 321 a structure with a diameter gradually increasing from top to bottom, so that the outer surface of the first clamping part 321 is an inclined outer surface, facilitating the first clamping part 321 to pass through the wire threading hole 11. Meanwhile, the hole wall of the wire threading hole 11 is clamped on the outer surface of the first clamping part 321 to limit the position of the retaining part 33.

The fixing structure 10 includes a cover 1 and a housing 2. The cover 1 is provided with a wire threading hole 11. The housing 2 is accommodated inside the cover 1. A wire threading groove 21 is provided on the housing 2 at a position corresponding to the wire threading hole 11. The wire threading hole 11 and the wire threading groove 21 are used for accommodating the clamping part 32 of the power cord 3 which passes through them. A fixing part 101 is formed between the housing 2 and the cover 1. The fixing part 101 is configured to accommodate and fix the retaining part 33. The wire threading hole 11 and the wire threading groove 21 are respectively provided on the upper and lower sides of the fixing part 101. The orthographic projection of the fixing part 101 exceeds the orthographic projection range of the wire threading hole 11 and the orthographic projection range of the wire threading groove 21 respectively, so that the clamping part 32 can pass through the wire threading groove 21 and the wire threading hole 11, but the wire threading groove 21 and the wire threading hole 11 limit and fix the retaining part 33 in the fixing part 101. Such an arrangement is to limit and fix the power cord 3 by means of the structures of the housing 2 and the cover 1 itself, without the need to additionally set wire pressing pieces or design protruding installation structures, thereby reducing the volume of the lamp 100 and lowering costs. In addition, the second clamping part 322 and the first clamping part 321 of the power cord 3 with smaller volumes can respectively pass through the wire threading groove 21 on the housing 2 and the wire threading hole 11 on the cover 1, while the retaining part 33 with a larger volume is limited and fixed in the fixing part 101 by the wire threading groove 21 and the wire threading hole 11, that is, limited and fixed by the shell walls of the housing 2 and the cover 1 themselves, thereby fixing and limiting the power cord 3 in the fixing structure 10, preventing the power cord 3 from being pulled off, making the installation of the power cord 3 firm and reliable, meeting the safety regulation requirements of anti-pulling and pushing, and omitting the lightning mark. Moreover, the power cord 3 does not need to be bent during installation, threading is easy, assembly is simple and easy to operate, and it has good convenience.

It should be noted that the above orthographic projection refers to the projection of the fixing part 101, the wire threading groove 21, or the wire threading hole 11 on a plane (horizontal plane in FIG. 4) perpendicular to the extending direction of the power cord 3 when viewed from the extending direction of the power cord 3 (vertical direction in FIG. 4).

Further, on the plane perpendicular to the extending direction of the power cord 3 (horizontal plane in the present example), the project areas of both the wire threading hole 11 and the wire threading groove 21 are larger than the project area of the clamping part 32 and smaller than the project area of the retaining part 33. Such an arrangement enables the clamping part 32 to smoothly pass through the wire threading hole 11 and the wire threading groove 21, while the retaining part 33 is limited and fixed in the fixing part 101 due to its large volume.

Further, the cover 1 is made of a heat-conducting material, such as aluminum or other suitable metal, non-metal, or composite materials, to facilitate heat dissipation. The cover 1 includes an outer base 12 and an outer side wall 13 extending from the periphery of the outer base 12 to the inner side of the outer base 12 and protruding in a direction away from the outer base 12. The outer base 12 and the outer side wall 13 together enclose a receiving cavity. The housing 2 is accommodated in the receiving cavity of the cover 1.

In some examples, a heat dissipation contact region 14 is provided on the cover 1 at a position corresponding to an installation opening 23 on the housing 2. The heat dissipation contact region 14 protrudes from the side of the outer side wall 13 of the cover 1 away from the outer base 12 toward the housing 2 and passes through the installation opening 23 to be proximal to the light-emitting component 4 of the lamp 100, so as to actively dissipate heat for the light-emitting component 4.

Further, the wire threading hole 11 is provided on the outer side wall 13 to avoid interfering with the heat dissipation efficiency of the heat dissipation contact region 14.

A plurality of first recessed regions 131 are provided at positions of the outer side wall 13 proximal to the outer base 12. A first fixing hole 15 penetrating through the outer base 12 is provided in each first recessed region 131. For example, the first fixing hole 15 is a locking hole configured for allowing a fastener 8 to pass through, so as to fixedly connect the cover 1, the housing 2, and the face ring 7 of the lamp 100.

In the present example, four first recessed regions 131 are provided, and the four first recessed regions 131 are evenly distributed on the outer side wall 13. Each first recessed region 131 is provided with a first fixing hole 15. Such an arrangement improves the stability of the connection of the lamp 100. It should be noted that the total number of the first recessed regions 131 and the first fixing holes 15 can be increased or decreased as needed, and the positions of the first recessed regions 131 and the first fixing holes 15 can also be set as needed, as long as the stable installation of the lamp 100 can be achieved.

Further, a plurality of second recessed regions 132 are provided on the outer side wall 13. A mounting clip 16 is installed in each second recessed region 132, and the mounting clip 16 is configured to install the entire lamp 100 into a corresponding installation area. For example, two mounting clips 16 are provided, and the two mounting clips 16 are arranged oppositely.

The housing 2 is made of an insulating material. The housing 2 includes an inner side wall 24, and the inner side wall 24 protrudes toward the cover 1 to form a receiving part for receiving the light-emitting component 4.

Further, an installation opening 23 is provided in the middle of the inner side wall 24, and the area of the installation opening 23 is equal to or greater than half of the area of the housing 2. Such an arrangement can form a large heat dissipation window while the light-emitting component 4 is received in the receiving part, so as to facilitate heat dissipation for the light-emitting component 4. Meanwhile, the installation opening 23 also facilitates the power cord 3 to pass through, solving the problem of difficult threading of the power cord 3.

Further, a fixing groove 22 is provided on the housing 2. The fixing groove 22 is provided on the inner side wall 24 and formed by recessing inward from the top surface of the housing 2. Optionally, the shape of the fixing groove 22 is consistent with the shape of the retaining part 33 of the power cord 3 to facilitate fixing the retaining part 33 in the fixing groove 22. In the present example, the fixing groove 22 is a square fixing groove 22. In other examples, the shape of the fixing groove 22 can also be other shapes.

Further, the fixing groove 22 and the cover 1 jointly form the fixing part 101, which is used to accommodate and fix the retaining part 33 of the power cord 3.

In some examples, the wire threading groove 21 is provided on the bottom wall 221 of the fixing groove 22 and penetrates through the bottom wall 221. On the plane perpendicular to the extending direction of the power cord 3, the project area of the wire threading groove 21 on the plane is smaller than the project area of the fixing groove 22 on the plane. That is to say, the wire threading groove 21 is provided on the fixing groove 22, and the wire threading groove 21 is a structure penetrating through the fixing groove 22, and the orthographic projection of the fixing groove 22 exceeds the orthographic projection range of the wire threading groove 21. Such an arrangement facilitates the clamping part 32 of the power cord 3 to pass through the wire threading groove 21, while the retaining part 33 is limited in the fixing groove 22 by the wire threading groove 21. At the same time, due to the existence of the cover 1, the top of the retaining part 33 is limited and fixed, so that the retaining part 33 is received and fixed in the fixing part 101, preventing the power cord 3 from being pulled off and meeting the safety regulation requirement of anti-pushing.

In some examples, an opening 211 is provided on the side of the wire threading groove 21 away from the edge of the housing 2, and the opening 211 is communicated with the installation opening 23. That is, the installation opening 23 is communicated with the fixing groove 22 through the wire threading groove 21. Such an arrangement facilitates both the retaining part 33 and the clamping part 32 of the power cord 3 to enter the upper part of the housing 2 through the installation opening 23, then the clamping part 32 arranged below the retaining part 33 enters the fixing groove 22 through the wire threading groove 21, and the clamping part 32 arranged above the retaining part 33 passes through the wire threading hole 11 on the cover 1. The circumferential area of the retaining part 33 is larger than that of the wire threading groove 21 and the wire threading hole 11, so the retaining part 33 is limited and fixed in the fixing groove 22 (or the housing 2) and the fixing part 101 formed by the cover 1.

In some examples, the fixing groove 22 further includes a side wall 222, the side wall 222 is perpendicular to the bottom wall 221, a protruding part (not shown) is provided on the side wall 222, and the protruding part extends from the side wall 222 to the inside of the fixing groove 22 to abut against the retaining part 33. By arranging the protruding part, the retaining part 33 is further fixed in the fixing part 101, preventing it from shaking in the fixing part 101, thereby improving the firmness of the retaining part 33 and meeting the safety regulation requirement of anti-pushing.

Further, a third recessed region 25 corresponding to the first recessed region 131 of the outer side wall 13 is provided on the inner side wall 24. A second fixing hole 26 penetrating through the inner side wall 24 is provided in the third recessed region 25, and the second fixing hole 26 corresponds to the first fixing hole 15 on the cover 1 to facilitate the passage of the fastener 8, realizing the fixed connection between the housing 2 and the cover 1.

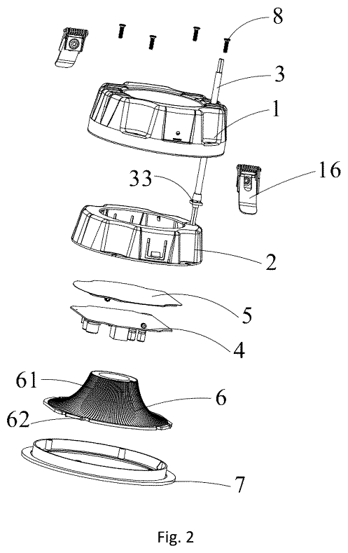

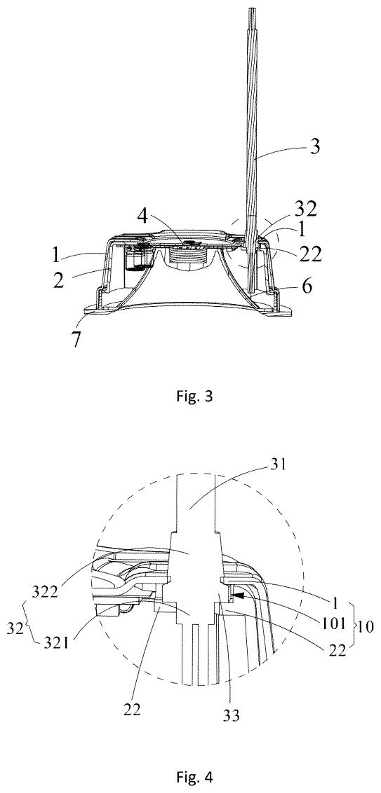

Please refer to FIGS. 2 and 3. The light-emitting component 4 is received in the receiving cavity of the housing 2, at least partially exposed in the installation opening 23, and corresponds to the heat dissipation contact region 14 on the cover 1 to facilitate heat dissipation. The light-emitting component 4 includes a circuit board, a plurality of light sources installed on the circuit board, and an auxiliary electronic device. In the present example, the light-emitting component 4 is a DOB light source electronic component. Of course, it can also be other suitable light sources or light source components, which are not limited here.

Further, the lamp 100 may further include a heat conducting member 5. The heat conducting member 5 is arranged between the light-emitting component 4 and the housing 2 and at least partially exposed in the installation opening 23 to correspond to the heat dissipation contact region 14 on the cover 1, facilitating the heat generated from the light-emitting component 4 to be transferred to the heat dissipation contact region 14 through the heat conducting member 5 for heat dissipation. The heat conducting member 5 can be a heat conducting silicone fabric or other suitable materials.

Further, to improve the light-emitting effect of the lamp 100, a lens 6 may be arranged on the side of the light-emitting component 4 away from the housing 2. A plurality of reflective prism blocks 61 are provided on the side of the lens 6 facing toward the light-emitting component 4 to improve the light-emitting effect of the lamp 100.

The face ring 7 is arranged on the side of the light-emitting component 4 facing away from the housing 2 and includes an outer edge part 71 and a connecting part 72 arranged inside the outer edge part 71. The connecting part 72 extends from the surface of the outer edge part 71 in a direction facing toward the light-emitting component 4. An anti-detachment groove 73 is provided between the outer edge part 71 and the connecting part 72, and the cover 1 is clamped in the anti-detachment groove 73 to improve the stability of the connection of the lamp 100.

Further, the face ring 7 further includes a foolproof protrusion 74 arranged on the side of the connecting part 72 facing away from the outer edge part 71. At least one of the lens 6 and the housing 2 is provided with a foolproof groove 62 matched with the foolproof protrusion 74 to facilitate quick and accurate positioning during assembly.

Further, third fixing holes 75 are provided on the face ring 7 at positions corresponding to the respective first fixing holes 15, and the fastener 8 passes through the first fixing hole 15, the second fixing hole 26, and the third fixing hole 75 to fixedly connect the cover 1, the housing 2, and the face ring 7.

When assembling the lamp 100 of the present disclosure, first, the power cord 3 is fixedly connected and electrically connected with the light-emitting component 4, then the power cord 3 passes through the installation opening 23 of the housing 2. After the light-emitting component 4 and the heat conducting member 5 are installed in the receiving cavity of the housing 2, the second clamping part 322 of the power cord 3 enters the wire threading groove 21 through the installation opening 23 on the housing 2, and the retaining part 33 is installed in the fixing groove 22. Due to the large volume of the retaining part 33, it cannot pass through the wire threading groove 21 and the wire threading hole 11, so it is fixed in the fixing groove 22 and limited and fixed by the fixing part 101 formed by the fixing groove 22 and the cover 1. The first clamping part 321 arranged above the retaining part 33 can smoothly pass through the wire threading hole 11 on the cover 1 to connect with an external power source. Then, after the lens 6 is installed, it is positioned and connected with the face ring 7 through the foolproof groove 62 and the foolproof protrusion 74. The fastener 8 passes through the first fixing hole 15, the second fixing hole 26, and the third fixing hole 75 to fixedly connect the cover 1, the housing 2, and the face ring 7. At this time, the retaining part 33 of the power cord 3 is clamped between the housing 2 and the cover 1, no additional wire pressing structure is needed, and the power cord 3 is easy to insert and pull out, which can meet the anti-pulling and pushing test of safety regulations.

In summary, the fixing structure 10 of the present disclosure has a simple structure. The fixing part 101 is formed between the housing 2 and the cover 1 to accommodate and fix the retaining part 33 of the power cord 3. The wire threading groove 21 and the wire threading hole 11 are respectively provided on the housing 2 and the cover 1. Meanwhile, the wire threading hole 11 and the wire threading groove 21 are respectively provided on the upper and lower sides of the fixing part 101, and the orthographic projection of the fixing part 101 exceeds the orthographic projection range of the wire threading hole 11 and the orthographic projection range of the wire threading groove 21 respectively, so as to limit and fix the retaining part 33 of the power cord 3 in the fixing part 101 through the wire threading hole 11 and the wire threading groove 21. Thus, there is no need to design too many additional structures, and the power cord 3 is limited and fixed by means of the structures of the housing 2 and the cover 1 itself. In addition, the power cord 3 does not need to be bent during installation, threading is easy, assembly is simple and easy to operate, and it has good convenience. At the same time, the power cord 3 is firmly installed, not easy to be pulled off by external force, meets the safety regulation requirements of anti-pulling and pushing, and the lightning mark is omitted.

The purpose of the present disclosure is to provide a fixing structure with a simple structure, easy threading, and firm fixing.

To achieve the above purpose, the present disclosure provides a fixing structure for fixing a power cord. The fixing structure comprises: a cover provided with a wire threading hole; a housing accommodated inside the cover, where a wire threading groove is provided on the housing at a position corresponding to the wire threading hole, and the wire threading hole and the wire threading groove are configured for allowing a clamping part of the power cord to pass through; a fixing part is formed between the housing and the cover, the fixing part is configured to accommodate a retaining part of the power cord, the retaining part is arranged on the clamping part and protrudes relative to the clamping part in a circumferential direction of the power cord; the wire threading hole and the wire threading groove are respectively provided on upper and lower sides of the fixing part, and an orthographic projection of the fixing part exceeds an orthographic projection range of the wire threading hole and an orthographic projection range of the wire threading groove respectively, so as to limit and fix the retaining part in the fixing part through the wire threading groove and the wire threading hole.

Optionally, a fixing groove is provided on the housing, the fixing groove is formed by recessing inward from a top of the housing, and the fixing groove and the cover jointly form the fixing part.

Optionally, the fixing groove comprises a bottom wall and a side wall, a protruding part is provided on the side wall, and the protruding part extends from the side wall to an inside of the fixing groove to abut against the retaining part.

Optionally, the wire threading groove is provided on the bottom wall of the fixing groove and penetrates through the bottom wall.

Optionally, an opening is provided on a side of the wire threading groove away from an edge of the housing, an installation opening is provided on the housing, and the opening is communicated with the installation opening.

Optionally, a heat dissipation contact region is provided on the cover at a position corresponding to the installation opening, the heat dissipation contact region is configured to dissipate heat for the light-emitting component of the lamp, and the heat dissipation contact region protrudes from the cover toward the housing and passes through the installation opening to be proximal to the light-emitting component.

Another purpose of the present disclosure is to provide a lamp with the above fixing structure.

To achieve the above purpose, the present disclosure provides a lamp, which comprises a power cord and the above fixing structure, the power cord comprises a clamping part and a retaining part, the retaining part is arranged on the clamping part and protrudes relative to the clamping part in a circumferential direction of the power cord.

Optionally, the lamp further comprises a light-emitting component and a face ring, the light-emitting component is fixedly connected and electrically connected with the power cord, the light-emitting component is arranged between the face ring and the housing and located on a side of the housing facing away from the cover; when the light-emitting component is fixed on the housing, the power cord is clamped and fixed in the fixing part through the wire threading groove.

Optionally, the face ring comprises an outer edge part and a connecting part arranged inside the outer edge part, an anti-detachment groove is provided between the outer edge part and the connecting part, and the cover is clamped in the anti-detachment groove.

Optionally, a first fixing part is provided on the cover, a second fixing part and a third fixing hole are respectively provided on the housing and the face ring at positions corresponding to the first fixing part, and a fastener passes through the first fixing part, the second fixing part, and the third fixing hole to fixedly connect the cover, the housing, and the face ring.

Compared other implementations, the technical solution of the example of the present disclosure has the following beneficial effects:

The fixing structure of the present disclosure has a simple structure. The fixing part is formed between the housing and the cover to accommodate and fix the retaining part of the power cord. The wire threading groove and the wire threading hole are respectively provided on the housing and the cover for the clamping part of the power cord to pass through. Meanwhile, the wire threading hole and the wire threading groove are respectively provided on the upper and lower sides of the fixing part, and the orthographic projection of the fixing part exceeds the orthographic projection range of the wire threading hole and the orthographic projection range of the wire threading groove respectively, so as to limit and fix the retaining part of the power cord in the fixing part through the wire threading hole and the wire threading groove. Thus, there is no need to design too many additional structures, and the power cord is limited and fixed by means of the structures of the housing and the cover itself. In addition, the power cord does not need to be bent during installation, threading is easy, assembly is simple and easy to operate, and it has good convenience. At the same time, the power cord is firmly installed, not easy to be pulled off by external force, meets the safety regulation requirements of anti-pulling and pushing, and the lightning mark is omitted.

The above examples are only used to illustrate the technical solution of the present disclosure and not to limit it. Although the present disclosure has been described in detail with reference to the examples, those of ordinary skilled in the art should understand that the technical solution of the present disclosure can be modified or equivalently replaced without departing from the spirit and scope of the technical solution of the present disclosure.

1. A fixing structure for fixing a power cord, comprising:
a cover, having a wire threading hole;
a housing, disposed inside the cover, wherein a wire threading groove is provided on the housing at a position corresponding to the wire threading hole, and the wire threading hole and the wire threading groove are configured to allow a clamping part of the power cord to pass through; and
a fixing part formed between the housing and the cover, the fixing part is configured to accommodate a retaining part of the power cord, the retaining part being disposed on the clamping part and protrudes relative to the clamping part in a circumferential direction of the power cord; the wire threading hole and the wire threading groove being disposed on upper and lower sides of the fixing part, and an orthographic projection of the fixing part exceeds an orthographic projection range of the wire threading hole and exceeds an orthographic projection range of the wire threading groove, so as to limit and fix the retaining part in the fixing part through the wire threading groove and the wire threading hole.

2. The fixing structure according to claim 1, wherein a fixing groove is provided on the housing, and the fixing groove is formed by recessing inward from a top of the housing, and the fixing groove and the cover jointly form the fixing part.

3. The fixing structure according to claim 2, wherein the fixing groove comprises a bottom wall and a side wall, a protruding part is provided on the side wall, and the protruding part extends from the side wall to an inside of the fixing groove to abut against the retaining part.

4. The fixing structure according to claim 2, wherein the wire threading groove is provided on the bottom wall of the fixing groove and extends through the bottom wall.

5. The fixing structure according to claim 1, wherein an opening is provided on a side of the wire threading groove opposite an edge of the housing, an installation opening is provided on the housing, and the opening communicates with the installation opening.

6. The fixing structure according to claim 5, wherein a heat dissipation contact region is provided on the cover at a position corresponding to the installation opening, the heat dissipation contact region is configured to dissipate heat for a light-emitting component of a lamp, and the heat dissipation contact region protrudes from the cover toward the housing and extends through the installation opening to be proximal to the light-emitting component.

7. A lamp, comprising:
a power cord, comprising a clamping part and a retaining part, wherein the retaining part is disposed on the clamping part and protrudes relative to the clamping part in a circumferential direction of the power cord; and
a fixing structure for fixing a power cord, wherein the fixing structure comprises:
a cover, having a wire threading hole;
a housing, disposed inside the cover, wherein a wire threading groove is provided on the housing at a position corresponding to the wire threading hole, and the wire threading hole and the wire threading groove are configured to allow a clamping part of the power cord to pass through; and
a fixing part formed between the housing and the cover, the fixing part is configured to accommodate a retaining part of the power cord, the retaining part being disposed on the clamping part and protrudes relative to the clamping part in a circumferential direction of the power cord; the wire threading hole and the wire threading groove being disposed on upper and lower sides of the fixing part, and an orthographic projection of the fixing part exceeds an orthographic projection range of the wire threading hole and exceeds an orthographic projection range of the wire threading groove, so as to limit and fix the retaining part in the fixing part through the wire threading groove and the wire threading hole

8. The lamp according to claim 7, further comprising a light-emitting component and a face ring, wherein the light-emitting component is fixedly connected and electrically connected with the power cord, the light-emitting component is arranged between the face ring and the housing and located on a side of the housing facing away from the cover; when the light-emitting component is fixed on the housing, the power cord is clamped and fixed in the fixing part through the wire threading groove.

9. The lamp according to claim 8, wherein the face ring comprises an outer edge part and a connecting part arranged inside the outer edge part, an anti-detachment groove is provided between the outer edge part and the connecting part, and the cover is clamped within the anti-detachment groove.

10. The lamp according to claim 8, wherein a first fixing hole is provided on the cover, a second fixing hole and a third fixing hole are respectively provided on the housing and the face ring at positions corresponding to the first fixing hole, and a fastener passes through the first fixing hole, the second fixing hole, and the third fixing hole to fixedly connect the cover, the housing, and the face ring.
